(19) United States
(12) Patent Application Publication
(10) Pub. No.: US 2004/0105441 A1
(43) Pub. Date: Jun. 3, 2004

(54) Router in an atm private terminal installation

(76) Inventors: Fabrice Bourgart, Perros Guirec (FR); Gilles Ramel, Lannion (FR); Regis Coat, Plouisy (FR); Bruno Le Corre, Lannion (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/344,136

(22) PCT Filed: Oct. 1, 2001
(86) PCT No.: PCT/FR01/03029

(30) Foreign Application Priority Data
Oct. 6, 2000 (FR) 00/12902

(51) Int. Cl. H04L 12/56

(52) U.S. Cl. 370/392; 370/395.31

(57) ABSTRACT

In a terminal installation (1), a router (2) connects ATM access networks (RA₁-RA_{M}) to individual installations (4) of terminals (7) so as to route cells therebetween according to a routing table (25). The router also routes cells containing routing addresses reserved for dialog with a collective control center (3) managing the routing table. The control center processes said cells with reserved routing address to allocate internal logic channels to the dialog between the control center and the terminals, and internal logic channels to incoming and outgoing communications with the terminals and internal communications between terminals, independently of the addressing scheme of the access networks.

The present invention is generally concerned with ATM mode private terminal installations installed on clients' premises.

French patent application FR-A-2 794 591 filed Jun. 3, 1999 and published Dec. 8, 2000 discloses a multiterminal client indoor installation connected to a telecommunication line of an access provider conveying ATM network cells. In this installation, broadcasting means broadcasts all the cells received via the receive channel of the telecommunication line to the terminals. This broadcasting of cells entails the risk of causing congestion of the terminal installation if the connections internal thereto constituted by local loops between the cell broadcasting means and cell collecting means are inadequate.

On the other hand, precisely because all the cells received are broadcast, the installation does not respect the confidentiality of calls between the users of terminals in the installation. This is because this kind of installation is intended for a single client, such as a residence or a small company.

The present invention aims to provide a router, not in an individual terminal installation, but in a private collective terminal installation in which the confidentiality of calls between client individual terminal installations is respected and in which the addressing scheme relating to the routing addresses of the cells conveyed in the collective installation is managed independently of the routing addresses in the cells transmitted to and received from access provider networks.

Accordingly, a router for an ATM terminal installation connecting external telecommunication lines of ATM access networks to internal telecommunication lines servicing terminals, is characterized in that it comprises:

a routing table for matching an unreserved routing address included in a cell received by the router to an unreserved routing address to be included in a cell to be sent from the router on one of the internal and external lines,

means for routing cells received by the router which contain reserved routing addresses and routing addresses unknown to the routing table and which are transmitted to the router from the terminals and the access networks, to a line reserved for management means for managing the installation, and

means for routing cells received with unreserved routing addresses read in the routing table and sent with corresponding routing addresses, between the internal lines and the external lines and between the internal lines.

The router does not broadcast standard ATM cells, but routes them as a function of a routing table in order to respect the confidentiality of calls with the individual installations. The routing set points respected by the router in accordance with the routing table are indicated by the management means, also called as a control center, which exchange reserve cells in particular with the terminals internal to the installation in order to dialog with them, in particular at the time of activating a terminal or a call set-up request. Assigning internal logical channels to the dialog with the management means or internal logical channels to conventional calls is independent of the addressing schemes of the access networks.

To be more specific, for directing the cells containing reserved routing addresses received by the router in an obligatory manner to the management means in order for the latter to respond to the terminals that sent the cells, the means for routing cells with reserved routing addresses and unknown routing addresses comprises means for detecting reserved routing addresses and routing addresses unknown to the routing table in cells received by the router, means for substituting the reserved routing addresses for the unknown routing addresses in the received cells, and means for marking the data field of each cell containing a reserved routing address with a number of an origin port of the router via which the cell was received, in order to route all the marked cells to the management means via the reserved line.

The invention also concerns an ATM terminal installation comprising the router according to the invention connecting external telecommunication lines of ATM access networks and internal telecommunication lines servicing terminals. The installation further comprises management means for managing the routing table included in the router in order to process the cells containing reserved routing addresses routed to the reserved line and to match unreserved routing addresses included in cells received by the router to unreserved routing addresses to be included in cells to be sent from the router.

Initially, each terminal contains at least one reserved routing address to be introduced into a cell sent by the terminal, in particular after activating it or for a call set-up request. Each cell that contains a reserved routing address to be sent by the terminal has a data field including an identifier of the terminal as a source identifier which will be a destination identifier in the response produced by the management means. In response to a marked cell containing the identifier of the terminal, the management means transmits to the terminal via the router a cell which contains the identifier of the terminal and an available routing address which corresponds, or to be more precise for example whose virtual path identifier corresponds to the origin port number included in the marked cell. The available routing address is to be included subsequently in any dialog cell from the management means to the terminal. The data field of the cell containing an available routing address and transmitted by the management means to the terminal includes, in addition to the identifier of the terminal, an available routing address assigned to a call with another terminal, in response to a routing address in the marked cell reserved for a call set-up request.

Preferably, the cells containing the reserved routing address are processed in a reserved routing address priority order by the management means.

Other features and advantages of the present invention will become more clearly apparent on reading the following description of plural preferred embodiments of the invention, which description is given with reference to the corresponding accompanying drawings, in which:

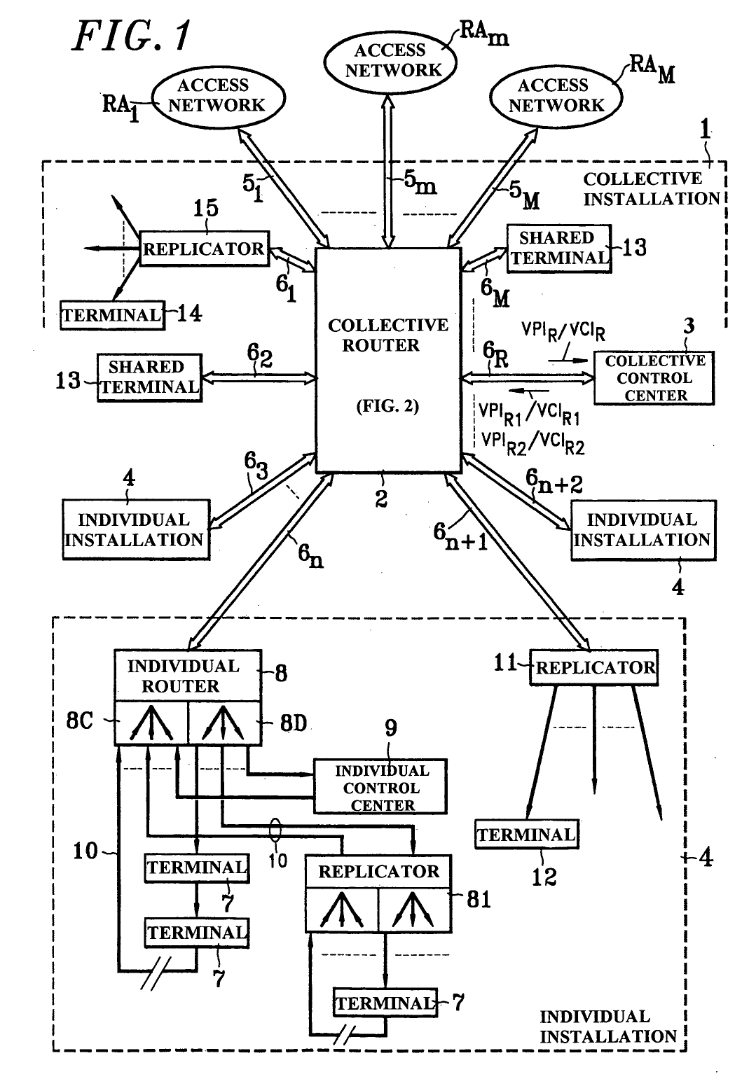

FIG. 1 is a block diagram of a client private collective terminal installation according to the invention;

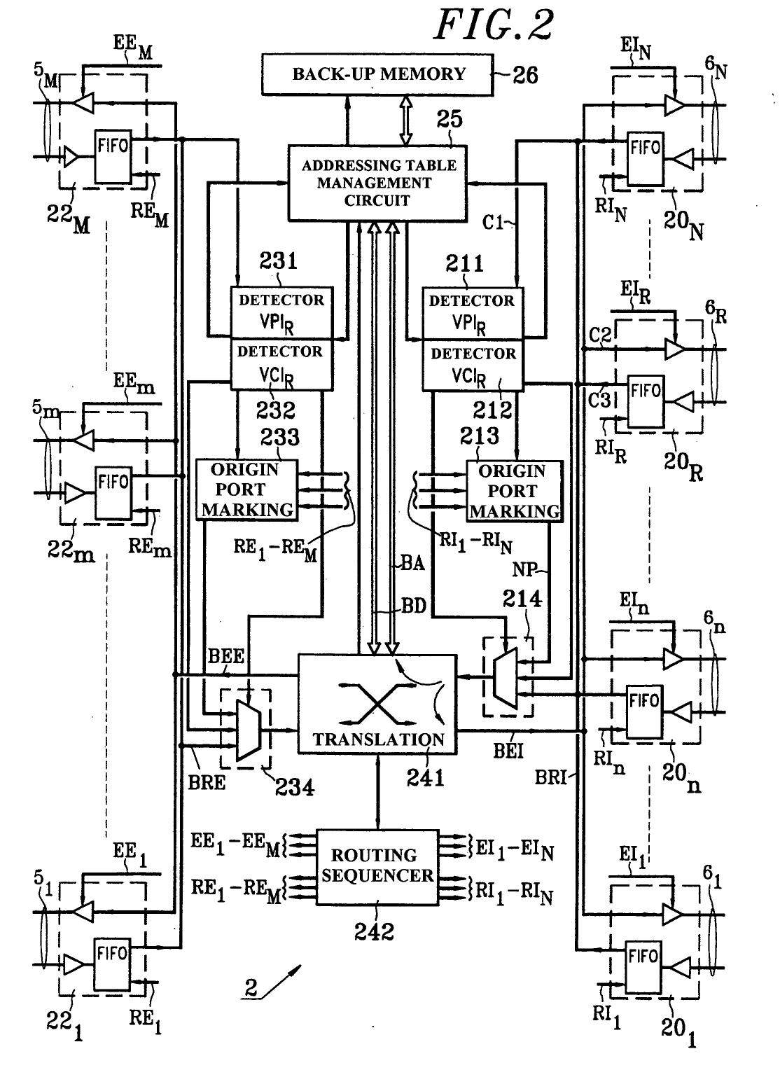

FIG. 2 is a block diagram of a collective router according to the invention included in the collective terminal installation; and

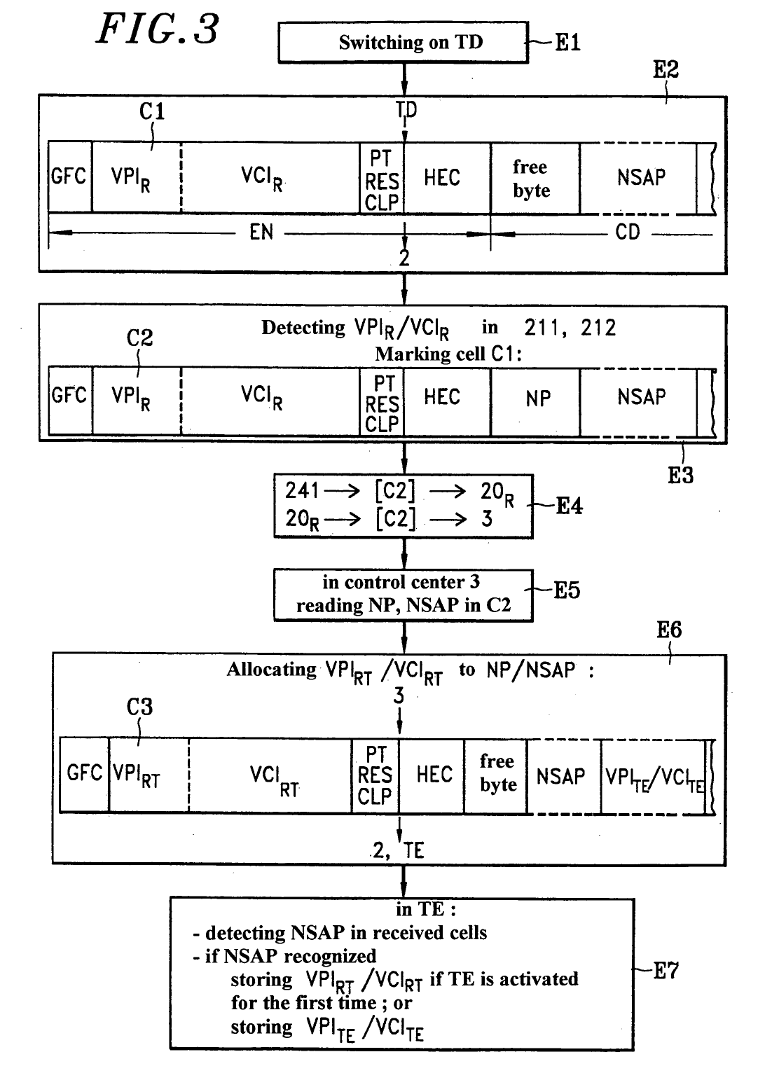

FIG. 3 is an algorithm for dialog between an internal terminal and a collective control center included in the collective terminal installation, notably during activation of the internal terminal.

As shown in FIG. 1, an ATM client private collective terminal installation 1 essentially comprises a collective router 2 associated with a collective control center 3, and plural client private individual terminal installations 4.

The collective router 2, a component essential to the invention and described in detail later, constitutes a collective gateway to the user network interface (UNI) with ATM access provider networks RA₁ to RA_{M}, which are generally telecommunication operators, where M≧1. In practice, the collective router 2 is serviced by at least as many external bidirectional telecommunication lines 5_{M} to 5_{M} as there are access provider networks RA₁ to RA_{M}, connected to network digital terminations (NDT), usually of the broadband ISDN type, able to support transmission in accordance with the xDSL technology, to convey streams of ATM network cells. However, as an alternative to this, an external line conveys signals in accordance with a transmission mode other than the asynchronous transfer mode, and the coupler of the collective router servicing this external line provides the adaptation between the asynchronous transfer mode and the external transmission mode.

Using a predetermined addressing table, the collective router 2 routes ATM cells coming from the external telecommunication lines 5₁ to 5_{M} to respective internal telecommunication lines 6₁ to 6_{N} connected in particular to the individual terminal installations 4. The internal lines 6₁ to 6_{N} also convey ATM cells in both transmission directions, but in relation in particular respectively to the individual installations. Accordingly, and reciprocally, the collective router 2 routes ATM cells, in particular from the individual terminal installations 4 via the internal telecommunication lines 6₁ to 6_{N} partly to the external telecommunication lines 5₁ to 5_{M} and partly to telecommunication lines internal to the collective terminal installation 1.

A private individual terminal installation 4 is the responsibility of a client in the collective entity associated with the collective terminal installation 1. For example, an individual terminal installation 4 is that distributed in an apartment in an apartment block in which the collective terminal installation 1 is arranged, or in an office in an office building in which the collective terminal installation is arranged, or in a department of a university or a business occupying a building in a complex of buildings in which the collective terminal installation is arranged. Accordingly, calls within an individual terminal installation are confidential and calls which are addressed to the exterior of the individual installation must obviously not be broadcast to the other installations.

The collective installation instead comprises several cascaded collective routers if the collective installation includes several “collective levels”, for example a building, a floor within the building, and individual installations on that floor; for example, the router 2 shown in FIG. 1 is connected by a few internal lines 6₁ to 6_{N} to respective first level collective routers which are connected to respective second level collective routers.

Externally to the individual installations 4, the collective terminal installation 1 comprises a set of resources for managing the collective installation, such as a collective control center 3 which is connected by a reserved internal telecommunication line 6_{R}. As will emerge hereinafter, the line 6_{R} is reserved for the control center 3 in the sense that the router has tagged the line 6_{R} with a respective address. Accordingly, the line 6_{R} is not dedicated to the control center 3 and can also service terminals, for example by means of a replicator.

The collective control center 3 controls all of the equipment units and installations included in the collective installation 1 and manages services and rights of access thereto, in particular with respect to the external telecommunication lines 5₁ to 5_{M} and shared resources. To be more specific, the collective control center 3 establishes routing set points for any call set-up requests coming either from internal lines when terminals are activated and for outgoing calls therefrom, or from external lines in the case of incoming calls, manages by default all call requests pertaining to calls that have not yet been set up, centralizes and cyclically refreshes a database containing information on the architecture and distribution of the individual installations 4 and shared equipment units, stores the identity and the location of new terminals when they are activated in the collective installation, manages a routing table in the collective router 2 in accordance with established routing set points, and presents local applications.

The collective control center 3 can instead be external to the collective installation 1, for example connected to it by an ATM dedicated line.

FIG. 1 shows in more detail one of the client individual terminal installations 4 connected to the internal line 6ₙ, where 1≦n≦N. It essentially comprises several terminals 7 on the premises of the client and connected to at least one respective internal telecommunication line 6ₙ via a private gateway consisting of an individual router 8. A terminal 7 can be a microcomputer, a home automation control and/or surveillance device, such as a video camera or a sensor, for example, a local server, a digital telephone, a cable television receiver, etc.

Like the collective router 2 in the collective terminal installation 1, the individual router 8 in the individual terminal installation 4 constitutes a communication node in the installation which is managed by an individual control center 9 and which services the terminals 7 via terminal telecommunication lines 10. The individual terminal installation 4 is a multiterminal client telecommunication installation, for example, as described in the French patent application FR-A-2794591 already cited.

In the individual installation, the individual router 8 comprises a broadcaster 8D for broadcasting ATM cells received via the respective internal line 6ₙ to the terminals 7 and a collector 8C for collecting ATM cells produced by the terminals 7 and transmitting them to the collective router 2 via the respective internal line 6ₙ. As shown in FIG. 1, the terminals 7 in the installation 4 are on digital transmission local loops constituted by the internal terminal lines 10 between output ports of the broadcaster 8D and input ports of the collector 8C. The individual router 8 also provides an intercommunication facility between terminals 7 in the installation 4 by broadcasting marked intercommunication cells produced by the terminals in the local loops 10 via the broadcaster 8D.

The individual router 8 can instead be a collective router, in order to have access to all the functions of a collective router, and in particular to assist with location of terminals in the individual installation.

Each terminal 7 is connected to a local terminal loop 10 via an ATM network interface or via an adapter if the terminal is a conventional telecommunication device with no network interface. The interface or the adapter receives ATM cells broadcast by the broadcaster 8D, inserts ATM cells produced by the terminal into the local loop, and repeats cells to be forwarded to other terminals in the local loop to the collector 8C. Couplers of send/receive ports in the broadcasters and collectors of the individual routers 8, as well as the terminals and their interfaces and adapters, are inventoried in a database of the individual control center 9 centralizing all information on the architecture of the individual terminal installation 4. As a general rule, information relating at least to the identification of the terminals 7 is also held in the collective control center 3.

In a variant, the individual control center 9 is external to the client premises of the installation 4, in the same way as the collective control center 3, and connected by a dedicated ATM line, for example.

An individual terminal installation 4 can be connected to the collective router by more than one internal line. For example, a second internal telecommunication line 6ₙ₊₁ connects the collective router 2 to a port replicator 11 which is included in the installation 4 and which services terminals 12 by broadcasting collective services. The replicator 11 has a structure analogous to that of the individual router 8, in other words it comprises an ATM cell broadcaster and an ATM cell collector, and provides no cell routing function and thus no intercommunication facility between the terminals 12, which are not able to communicate with each other. The replicator 11 broadcasts only information from each of its output ports. To maintain the confidentiality of information broadcast to the terminals 12, the internal telecommunication line 6ₙ₊₁ to which the replicator 11 is connected is unidirectional, and the replicator 11 does not forward any ATM cell to the collective router 2.

Replicators 11 can be connected in cascade, including on the far side of an individual router 8, like the bidirectional replicator 81 shown in FIG. 1.

As also shown in FIG. 1, the client private collective terminal installation 1 can also include resources shared between the clients who own the individual installations 4. These shared resources include shared terminals 13, some of which can each be connected by an internal telecommunication line 62, ⁶N, and others of which can be connected in cascade by a telecommunication line forming a loop, like an internal loop 10 in an individual installation 4. A shared terminal 13 constitutes a “fixed” terminal providing services to all clients in the collective installation who are authorized by the collective control center 3 directly or from a terminal 7 of an individual installation 4 or from a roaming terminal of an authorized visitor client who is present temporarily in the installation 1. Like the terminals 7, a terminal 13 contains an adapter for receiving, inserting and repeating ATM cells if it does not already have a network interface compatible with the transmission format used in the collective installation 1.

A shared terminal 13 is a printer, a facsimile machine, a building entryphone, a washing machine or a service application server, for example.

Other shared terminals 14 can be connected to the collective router 2 via a replicator 15, in an analogous manner to the replicator 11 and the terminals 12 in an individual installation 4. The terminals 14 are TV receivers, for example, or surveillance monitors of the collective entity associated with the installation 1.

A telecommunication line 6ₙ internal to the collective installation 1 or a telecommunication line 10 internal to an individual installation 4 can comprise a pair of metal wires or a monomode, multimode or plastics material optical fiber, or, at least in part, a radio channel. For example, the bit rate in a telecommunication line 6ₙ, 10 is 32 Mbit/s and corresponds to a predetermined bit rate of (4/5)32=25.6 Mbit/s on the far side of a send/receive coupler in the collective router 2 or the individual router 8, or a replicator 11, 15 after a binary 5B-to-4B receive transcoding and a binary 4B-to-5B send transcoding. In another variant, the in-line bit rate can be higher, for example 155.52 Mbit/s, the transcoding being of the 8B-to-10B type, and the cells delimited by 27-cells frames.

Given that some ATM cell fields are processed in the collective router 2 and the collective control center 3 according to the invention, the format of an ATM cell is described briefly hereinafter with reference to the cell C1 shown in step E2 in FIG. 3. An ATM cell comprises a header EN including five bytes and a data field CD constituting a payload with a constant size of 48 bytes.

The first field of the header relates to generic flow control (GFC) and has four bits.

The next six half-bytes of the cell header are occupied by a routing address field VPI/VCI containing a virtual path identifier (VPI) on one byte and a virtual channel identifier (VCI) on two bytes. For example, in the collective installation 1, a virtual path comprises an internal telecommunication line 6ₙ and a virtual channel on this line is allocated by the collective control center 3 to bidirectional communication with a terminal serviced by that line as will be seen below. To give another example, a VPI designates a set of internal telecommunication lines to which VCI are allocated dynamically by the control center 3. To give a further example, a single predetermined VPI is allocated to the collective installation 1, and the control center 3 manages the allocation of VCI identifiers of the virtual channels of the path designated by the predetermined VPI identifier to the lines 6₁ to 6_{N} internal to the collective installation.

In other variants, the VPI and VCI identifiers relating to virtual channels internal to the installation 1 occupy only a portion of the address field VPI/VCI comprising three bytes.

The second half-byte of the fourth byte of the header comprises three fields PT, RES and CLP that are not relevant to the invention.

The fifth and final byte of the header of an ATM cell constitutes a header error control field HEC. Before sending the cell, the content of the field HEC is computed as a function of the first four bytes of the cell by a predetermined algorithm. After the cell is received, the field HEC is used to correct single errors in the header of the cell as received and to reject the cell if more than one error is detected in the cell or if errors are detected in a predetermined number of consecutive cells on the same logical channel VPI/VCI. If it is correct, the field HEC also serves as a cell delimiter.

Hereinafter, it will be assumed that the field HEC in an ATM cell passing through the collective router 2 or the collective control center 3 is recomputed each time that the routing address field VPI/VCI in particular is modified, replaced or translated.

The data field CD of a cell in the installation can be used to route some parameters for initializing a terminal or a call, such as routing addresses, a port number NP, a terminal identifier NSAP, a control field which can contain a class indicator or keywords expressing a request from terminals having a common function, a terminal location indicator, as well as requests, commands or acknowledgements, and finally a check word (checksum) for checking the integrity of the data field.

Referring to FIG. 2, the collective router 2 essentially comprises send/receive couplers 20₁ to 20_{N} and means for detecting predetermined routing addresses 211-214 in relation to telecommunication lines 6₁ to 6_{N} internal to the collective installation 1, send/receive couplers 22₁ to 22_{N}, and means for detecting predetermined routing addresses 231-234 in relation to telecommunication lines 5₁ to 5_{M} external to the collective installation, together with logical channel switching means 241-242 and addressing means 25-26 arranged at the core of the collective router 2, between the aforementioned entities 20₁-20_{N}, 211-214 and 22₁-22_{M}, 231-234, for routing ATM cells between internal lines and external lines and between different internal lines, in accordance with a routing table managed by the collective control center 3.

Each send/receive coupler 20ₙ, 22ₘ, where 1≦n≦N and 1≦m≦M, comprises a send coupler and a receive coupler. The send coupler forwards ATM cells from a send bus BEI, BEE internal to the collective router 2 to an output port connected to the respective internal transmission line 6ₙ or to the respective external transmission line 5ₘ. During this forwarding, the send coupler serializes each cell byte, frames the cells, where applicable, and scrambles and transcodes the stream of cells to be sent. Reciprocally, the receive coupler forwards cells from the respective internal transmission line 6ₙ or from the respective external transmission line 5ₘ to a receive bus BRI, BRE internal to the collective router. In particular, the receive coupler transcodes and descrambles the stream of cells received, removes the frame configuration therefrom, where applicable, and converts each byte to parallel form.

Reading and writing ATM cells byte by byte are controlled cyclically by send and receive control signals produced by a routing sequencer 242 in the cell switching means. The sequencer is closely associated with the timebase (not shown) of the collective router.

The cells routed on the internal send bus BEI are read cyclically in the send couplers 20₁ to 20_{N} ON under the control of send control signals EI₁ to EI_{N}. The cells received by the receive couplers 20₁ to 20_{N} are written cyclically onto the internal receive bus BRI under the control of receive control signals RI₁ to RI_{N}. Similarly, externally to the collective installation 1, the send couplers 22₁ to 22_{M} read cells cyclically on the external send bus BEE under the control of send control signals EE₁ to EE_{M}, and cells received by the receive couplers ²²¹ to ²²M are written onto the external receive bus BRE under the control of receive control signals RE₁ to REM.

FIFO buffers in the receive couplers, at the input of the receive buses BRI and BRE, absorb any traffic congestion of ATM cells incoming into the collective router 2 and coming from the interior and the exterior of the collective installation.

Each predetermined routing address detecting means on the collective installation side and on the access network side essentially comprises a control center address detector 211, 231, a reserved routing address detector 212, 232, an origin port marking circuit 213, 233, and a multiplexer 214, 234.

The control center address detector 211, 231 holds in memory an address of the collective control center 3 which is assumed, for clarity, to comprise a virtual path identifier VPIR allocated to the internal telecommunication line 6_{R} servicing the collective control center 3 and thus identifying the port of the collective router materialized by the coupler ²⁰R. The address VPI_{R} is originally written into memory in the detector 211, 231 of the router, or is transmitted to the router 2 by the control center 3 in order for it to be written into the detector 211, 231 during a router initialization phase.

As already stated, any internal line 6₁ to 6_{N} connects the collective control center 3 to the collective router 2, and consequently any routing address VPIR/VCIR can obviously be allocated to the control center 3. Allocating the address VPI_{R} to the collective control center 3 in the detector 211, 231 beforehand, and more particularly the prior allocation of several routing addresses VPIR/VCIR reserved for the control center, in particular for differentiating qualities of services, avoids subsequent attempts to allocate logical channels intended for calls to the control center to an individual terminal installation 4, or a shared terminal 13, or a replicator 15, for example.

The reserved routing address detector 212, 232 holds in memory addresses VCI_{R} of virtual channels reserved for the collective control center 3 and forming reserved routing addresses VPI_{R}/VCI_{R} with the identifier of the control center 3 in cells forwarded by the router 2 to the control center 3 via the reserved line 6_{R}. The routing addresses VPI_{R}/VCI_{R} reserved for the control center are initially introduced into the memory of each terminal 7, 13 in the collective installation 1 while configuring it and prior to activating it. Thus the detectors 211-212, 231-232 detect on the receive bus BRI, BRE routing addresses VPI_{R}/VCI_{R} included in the address fields of cells transmitted by the terminals 7, 13, for example on switching on a terminal, or at the time of a call set-up request from a terminal, or for calls for the control center from an access network, for example for communication with an internal terminal, or for downloading a particular application into the control center.

Several routing addresses VPI_{R}/VCI_{R} are preferably reserved for the control center in order to assign them to respective actions relating to the control center, to the terminals, and to applications.

The collective control center 3 then contains as many FIFO queues as classes of actions requested of the control center in incoming cells and requested of the terminals in order to read them in a predetermined priority order in the outgoing cells. For example, a call request from a conventional terminal to an access network has priority over a periodic operating status message transmitted by a home automation terminal but does not have priority over an alarm message sent by a fire detector.

The priority order can depend not only on actions relating to the control center and the terminals, but also on predetermined applications and/or predetermined phases of applications in order to conform to an ATM quality of service.

The priority order for processing cells in the control center 3 as a function of the reserved addresses VPI_{R}/VCI_{R} is independent of the cell loss priority (CLP) bit in the header of an ATM cell.

Accordingly, the detectors 211-212, 231-232 scan the respective bus BRI, BRE to detect the routing address fields in the received ATM cells and to compare them to the reserved routing addresses VPI_{R}/VCI_{R} stored in memory, and thus detect any routing address in a received cell that is different from the reserved addresses stored in memory. In this latter case, the unknown routing address in the received cell is sent to the addressing means 25-26 in order to check if it is in an addressing table. If not, the addressing means controls the detectors 211-212, 231-232 to replace the unknown routing address with a predetermined reserved address VPI_{R}/VCI_{R} so that the corresponding cell is transmitted to the collective control center 3.

The origin port marking circuit 213, 233 identifies the origin port NP, i.e. the receive coupler 20₁ to 20_{N}, 22₁ to 22_{M} through which is received a cell containing either a reserved routing address VPI_{R}/VCI_{R} detected or a reserved routing address VPI_{R}/VCI_{R} after an unknown routing address is detected. The marking circuit 213 or 233 introduces the port number NP=n or NP=m of the corresponding receive coupler 20ₙ or 22ₘ into the first byte of the data field of the received cell. Origin port marking is used so that the control center can send a response cell back to the origin port via which a terminal has transmitted a cell with a reserved address.

When there are several routers 2 in cascade, for example on a floor of a building, in an apartment, and in a room, each router marks the cell with a port number corresponding to the internal line servicing the floor, the apartment or the room, with the result that the router connected to the collective control center 3 sends cells marked with three port numbers.

No marking is effected for cells sent by the collective control center 3 and coming from the associated receive coupler 20_{R}.

Just like the origin port marking circuit 213, 233, the multiplexer 214, 234 is controlled by the routing address detectors 211-212, 231-232 to insert the origin port number, as the sixth byte of a cell at the start of the data field of this cell, into each cell to be marked. Where necessary, the detectors 211-212, 231-232 control the multiplexer 214, 234 to substitute a reserved routing address for an unknown routing address, under the control of the addressing means 25-26.

The logical channel switching means comprises an interconnection matrix 241 associated with a routing sequencer 242. The interconnection matrix 241 mainly translates routing addresses VPI/VCI in the ATM cells received via the receive buses BRI and BRE into translated routing addresses before sending the cells on the respective buses BEI and BEE. According to the translated address, a cell received via the bus BRI internal to the collective installation 1 is routed either to the send bus BEI, which is also on the collective installation side, if two terminals 7, 13 are communicating or if a terminal and the collective control center 3 are communicating, or to the send bus BEE, which is on the side of the access networks RAl to RAM in the case of a call between a terminal and the exterior of the installation.

The routing sequencer 242 produces respective receive control signals RI₁ to RI_{N} and RE₁ to RE_{M} for sequentially opening the receive couplers 20₁ to 20_{N} and 22₁ to 22_{M} and produces respective send control signals EI₁ to EI_{N} and EE₁ to EE_{M} for sequentially opening the send couplers as a function of the routing of the cells with the translated routing addresses. The receive control signals RI₁ to RI_{N}, RE₁ to RE_{M} are also applied to the respective marking circuit 213, 233 which marks the origin port, i.e. the origin receive coupler through which the received cell to be marked has passed.

The routing addresses VPI/VCI are translated in the interconnection matrix 241 as a function of the correspondence between routing addresses stored in memory in an addressing table management circuit 25 essentially constituting the addressing means.

The addressing table generally matches a routing address VPI/VCI in a cell transmitted by a terminal or the like of the collective installation 1 to a routing address VPI/VCI identifying a destination logical channel on the side of the access networks RA₁ to RA_{M}, and conversely for the opposite transmission direction, for a call between the interior and the exterior of the collective installation.

The correspondence of routing addresses is not relevant to the addresses reserved for the control center and relates to permanent and temporary connections set up by the collective control center 3 at the call set-up time. A pair of addresses allocated to a permanent or temporary connection bidirectionally associates virtual channels in two internal transmission lines 6₁ to 6_{N}, or a virtual channel in an external access network line 5₁ to 5_{N} and a virtual channel in an internal telecommunication line 6₁ to 6_{N}.

A permanent connection is needed for some applications, in an analogous manner to leased telecommunication lines. For example, a permanent connection is used to connect a terminal consisting of a permanent video camera for detecting break-ins monitored remotely by a server on one of the access networks RA₁ to RA_{M}.

A permanent connection between the collective control center 3 and each access network RAₘ is essential so that the collective installation and thus any terminal in it can be called.

A temporary connection conventionally relates to a telephone or data call during a finite period involving at least one terminal or the like of the installation 1. The collective control center 3 allocates a routing address VPI/VCI, or to be more precise a logical channel to the terminal as a function of the logical channel resources available in the installation 1 at the time of a call set-up request described later with reference to FIG. 3.

A temporary connection is time-shared by several terminals. The corresponding pair of routing addresses is allocated to any of these terminals between seizing and release of the virtual channel, which is analogous to seizing and release of the line in conventional telephony.

A corresponding pair of routing address, i.e. of logical channels, is written permanently or temporarily and dynamically into the routing table programmed by the collective control center 3 as and when connection set-up requests are submitted, and preferably in a reserved routing address priority order, as already mentioned. For each permanent or temporary connection set up, routing addresses in the cells received via the interconnection matrix 241 are translated automatically by using the routing address of the received cell as an address for reading the routing table, in order to read therein the corresponding translated routing address to be introduced into the header of the cell, which can then be sent. The cells are routed from one port to another without passing through the collective control center 3.

Thus the addressing table circumvents constraints on addressing access networks RA₁ to RA_{M} external to the collective installation 1. The collective installation manager can, in the collective control center 3, allocate routing addresses VPI/VCI relating to logical channels internal to the installation, at least during activation of the installation, without worrying about constraints on addressing external access networks, which may differ fundamentally, as a function of the access provider. Translating routing addresses in the interconnection matrix 241 in accordance with the addressing table in the management circuit 25 programmed by the control center 3 thus ensures that addresses within the collective installation are independent of addresses external to it.

The addressing means further includes a non-volatile memory 26 for backing up the addressing table, i.e. the correspondences between the routing addresses of received cells and the routing addresses of sent cells. The addressing table is therefore backed up in the memory 26 in the event of a power failure at the collective router. The back-up memory 26 is updated after introducing a new address into or changing an existing address in the addressing table 25 between cell processing operations, at times when there is no call on the addressing table memory internal to the circuit 25. The back-up memory 26 also stores in memory the virtual path identifier VPI_{R} corresponding to the line 6_{R} connected to the collective control center 3 and the list of virtual channel addresses VCI_{R} reserved for communication with the control center.

Briefly, three main types of routing address VPI/VCI are provided in cells routed in the collective terminal installation 1.

A first type of routing address relates to “standard” ATM cells for a permanent or temporary call authorized by the control center 3 between a terminal 7, 13 and a terminal external to the installation, i.e. between a virtual channel on one of the internal telecommunication lines 6₁ to 6_{N} and a virtual channel on one of the external telecommunication lines 5₁ to 5_{M} or on one of the internal lines in accordance with corresponding routing addresses stored in memory in the addressing table 25, i.e. in accordance with non-reserved routing addresses known from the table.

A second type of routing address relates to ATM cells for dialog with the control center 3 and each containing a reserved address VPI_{R}/VCI_{R}.

A third type of routing address relates to ATM cells intended for configuring the routing table 25 and sent by the control center 3, as well be seen below.

Referring to FIG. 3, a dialog between the collective control center 3 and any terminal 7, 13 or like terminal means 9, 11, 15, hereinafter called as a terminal TE, in the collective terminal installation 1 comprises the following steps E1 to E7 when the terminal TE is activated for the first time.

After the terminal TE is switched on in step E1, and after synchronization has been recovered at the level of the line internal to the installation to which the terminal TE is connected, the terminal TE sends the collective router 2 an ATM recognition cell C1 (step E2). The routing address field of the cell C1 contains a routing address VPI_{R}/VCI_{R} reserved exclusively for activating any terminal of the collective installation 1.

A single identifier NSAP of the terminal TE is included in the data field (payload) of the recognition cell C1. The terminal identifier NSAP (Network Service Access Point) typically extends over twenty bytes following the second byte of the data field, the first byte of the data field being free in the cell C1 sent by the terminal TE. The identifiers NSAP designate respective terminals in an ATM network. The identifier NSAP typically begins with three bytes indicating the format of the identifier and the authority by which that format was defined, followed by ten bytes made available to the client or the operator for identifying the location of the terminal as a function of its own ATM addressing scheme, six bytes identifying the terminal itself, and often fixed once and for all in the ATM adapter or interface that the terminal contains, and a final byte for addressing a software task in the terminal identified by the preceding 19 bytes.

Three to six less significant bytes in the six bytes made available to the client are reserved for a “sub-network” address designating the collective installation 1.

The six bytes identifying the terminal itself contain an identifier of the manufacturer of the terminal, an identifier IT of the terminal type, and a serial number, in an analogous manner to a medium access control (MAC) address.

After the cell C1 sent by the terminal is received in the corresponding coupler 20₁ to 20_{N} of the collective router 2 in the next step E3, the addressing field in the header of the cell C1 on the receive bus BRI is read by the detectors 211 and 212 which recognize therein the identifier VPI_{R} of the virtual path 6_{R} allocated to the control center 3 and the identifier VCI_{R} of the virtual channel reserved for activating a terminal. The detectors 211 and 212 consequently control the marking circuit 213 to mark the cell C1 by introducing into the first byte of the data field the port number NP corresponding to the receive coupler 20₁ to 20_{N} through which the cell was received. The receive coupler is identified as a function of the respective receive control signal RI₁ to RI_{N} produced by the sequencer 242. Consequently, at the output of the multiplexer 214, the first byte of the data field of the marked received cell C2 is occupied by the number NP of the corresponding receive port.

In step E4, the addressing table 25, on recognizing that the marked cell C2 contains an address reserved for the control center, routes the cell C2 through the interconnection matrix 241, which does not effect any translation, from the output of the multiplexer 214 to the internal send bus BEI in the direction of the send coupler 20_{R} connected to the collective control center 3 and opened by the sequencer 242.

In step E5, the marked cell C2 is processed by the control center 3, which reads therein the terminal identifier NSAP and extracts therefrom the port number NP in order to associate them in its internal memory, which enables the control center to locate the terminals in the installation and thus to indicate a list of terminals in a class requested by a user of the collective installation.

In step E6, the control center 3 allocates to the terminal TE, in other words to the pair NSAP-NP, an available routing address VPI_{RT}/VCI_{RT} which contains the virtual path identifier VPI_{RT} corresponding to the port number NP, in order to send a cell back to the corresponding send coupler of the collective router. In response to the marked received cell C2, the control center 3 transmits an unmarked ATM acknowledgement cell C3 having a header containing the routing address VPI_{RT}/VCI_{RT} allocated to the terminal TE and a data field CD containing, starting from the second byte, the terminal identifier NSAP. The cell C3 being transmitted by the control center 3 via the coupler 20_{R} is not marked in the router 2 and passes through the bus BRI, the multiplexer 214, the interconnection matrix 241 and the send bus BEI, for forwarding to the send coupler 20₁ to 20_{N} of the collective router corresponding, among others, to the routing address VCI_{RT}/VPI_{RT} previously allocated, i.e. corresponding to the origin port NP, and designating a logical channel on the internal line 6₁ to 6_{N} servicing the terminal TE directly or indirectly.

In step E7 the terminal TE continuously scans the line to which it is connected, which it has in fact been doing since the sending of the recognition cell C1 in step E2, to read the data fields of all ATM cells received thereon and thus to compare the twenty bytes of the terminal identifier location with its own terminal identifier NSAP. If the terminal TE recognizes the identifier NSAP in the acknowledgement cell C3 sent by the control center in step E6, it stores in memory the routing address VPI_{RT}/VCI_{RT} allocated to it by the control center 3 and included in the cell C3. The routing address VPI/VCI allocated is used systematically for any subsequent downlink call from the collective control center 3 to the terminal TE. Accordingly, provided that the terminal TE is not switched off or moved, dialog with the control center 3 is effected by means of cells transmitted in the downlink direction from the control center 3 to the terminal TE on the virtual channel corresponding to the routing address VPI_{RT}/VCI_{RT} allocated by the control center 3 to the terminal TE and by means of cells transmitted by the terminal TE to the control center 3 in the uplink direction on the virtual channel corresponding to a routing address VPI_{R}/VCI_{R} reserved for the control center 3 and thus known to the detectors 211 and 212 in the collective router 2.

After step E7, the terminal TE can go to the standby mode or be switched off.

If, subsequently, after activating it, the terminal TE requests the collective control center 3 to set up an outgoing call to a local called terminal in the installation or to a remote terminal in the access networks, for a temporary or permanent connection, steps analogous to steps E1 to E7 are executed, but with the allocation of an available routing address VPI_{TE}/VCI_{TE} to the terminal TE for bidirectional communication with the local or remote terminal. The collective control center 3 recognizes cells C1 that become marked cells C2 and contain a predetermined routing address VPI_{R}/VCI_{R} reserved for a call set-up request. In step E6, the control center 3 then further introduces the available routing address VPI_{TE}/VCI_{TE} into the data field of the cell C3, after the terminal identifier NSAP, which is then read and stored in memory in the calling terminal TE in step E7.

Virtually simultaneously with step E6, the collective control center 3 matches to the address VPI_{TE}/VCI_{TE} a routing address of an internal logical channel to the local terminal or an external logical channel to the remote terminal and updates the addressing table 25 in the collective router 2 by means of an ATM configuration cell conforming to the third type previously cited, as described below.

The allocation of an internal logical channel and therefore of an internal routing address to the terminal TE becoming the called terminal for an incoming call whose set-up is requested for a local or remote calling terminal is effected in substantially the same manner. Steps E1 to E5 are executed between the local or remote calling terminal and the collective control center 3 and steps E6 and E7 are executed between the called terminal TE and the control center 3. The routing address VPI_{TE}/VCI_{TE} allocated to the incoming call by the control center 3 then corresponds to the routing address that designates the logical channel by means of which the calling terminal is communicating with the control center, these two routing addresses being written in the routing table 25 by the control center 3.

As already stated, the third routing addresses VPI/VCI internal to the collective installation 1 are reserved for configuring the addressing table in the circuit 25 and are sent to the collective router 2 by the collective control center 3 in configuration cells and via the internal reserved line 6_{R}. The routing address field in the header EN of a configuration cell contains either a first reserved address VPI_{R1}/VCI_{R1} for controlling the introduction of a new internal and external routing address pair or a new pair of internal routing addresses into the addressing table of the circuit 25, or a second reserved address VPI_{R2}/VCI_{R2} for modifying an internal routing address in an internal and external routing address pair or in a pair of internal routing addresses. Accordingly, and as a function of the routing address in the routing address field of the ATM cells received via the coupler 20_{R} connected to the collective control center 3, the reserved address detectors 211 and 212 prepare the addressing table management circuit 25 to process each configuration cell directed by the interconnection matrix 241 to the circuit 25 when one of the reserved addresses VPI_{R1}/VCI_{R1} and VPI_{R2}/VCI_{R2} is recognized.

A new pair of routing addresses is introduced into the addressing table of the circuit 25 in the following manner. The data field CD of the configuration cell whose header includes the reserved routing address VPI_{R1}/VCI_{R1} transmitted by the collective control center 3 contains a first routing address VPI/VCI of the new pair to be stored relative to a logical channel for the reception of cells in the collective router, and a second routing address VPI/VCI of the new pair to be stored relative to a logical channel for sending cells from the collective router. The first routing address of the pair is placed on the address bus BA of the addressing table and the second routing address of the pair is placed on the data bus BD of the addressing table and stored in memory therein for one transmission direction via the collective router 2. Conversely, the second routing address of the pair is placed on the address bus BA of the addressing table, and the first routing address of the pair is placed on the data bus BD of the addressing table and stored in memory therein for a logical channel in the opposite transmission direction via the collective router 2. After these storage operations, the back-up memory 26 is updated in correspondence with the addressing table under the control of the circuit 25.

When an ATM cell transmitted by the collective control center 3 is directed by the interconnection matrix 241 to the management circuit of the addressing table 25 in response to the detection of the second reserved address VPI_{R2}/VCI_{R2} in the header of the cell by the detectors 211 and 212, the circuit 25 places the first routing address contained in the data field of the received cell on the addressing bus BA of the addressing table and places the second routing address contained in the data field of the received cell on the data bus BD of the addressing table in such a manner as to store the second routing address in memory and substitute it for the routing address that was already stored in memory. If the first routing address which is to be placed on the address bus BA of the addressing table must only be modified, then the pair containing the address to be translated and modified follows the preceding procedure relating to a configuration cell containing the first reserved address VPI_{R1}/VCI_{R1} for storing in memory a new pair of routing addresses.

As previously, after any address modification, the back-up memory 26 is updated under the control of the circuit 25.

Accordingly, on receiving a standard ATM cell, the interconnection matrix 241 extracts the routing address in the header of the cell received to place it on the address bus BA of the addressing table 25 so that a corresponding translated routing address is read therein and fed via the data bus BD to the matrix 241, which introduces it into the routing field of the received cell, which becomes a cell to be sent by the collective router 2.

What we claim is:

1- a router (2) for an atm terminal installation (1) connecting external telecommunication lines (5₁-5_{M}) of atm access networks (ral-ram) to internal telecommunication lines (6₁-6_{N}) servicing terminals (7, 13), characterized in that it comprises:
a routing table (25) for matching an unreserved routing address (VPI/VCI) included in a cell received by the router to an unreserved routing address to be included in a cell to be sent from the router on one of the internal and external lines,
means (211-214, 231-241) for routing cells received by the router which contain reserved routing addresses (VPI_{R}/VCI_{R}) and routing addresses unknown to the routing table (25) and which are transmitted to the router from the terminals (7) and the access networks (RA₁-RA_{M}), to a line (6_{R}) reserved for management means (3) for managing the installation (1), and
means (241, 242; 25) for routing cells received with unreserved routing addresses (VPI/VCI) read in the routing table (25) and sent with corresponding routing addresses, between the internal lines and the external lines and between the internal lines.

2- A router according to claim 1, characterized in that the means for routing cells with reserved routing addresses and unknown routing addresses comprises means (211, 212, 231, 232) for detecting reserved routing addresses (VPI_{R}/VCI_{R}) and routing addresses unknown to the routing table (25) in cells (C1) received by the router, means (211, 212, 231, 232, 25) for substituting the reserved routing addresses for the unknown routing addresses in the received cells, and means (213, 233) for marking the data field of each cell containing a reserved routing address with a number (NP) of an origin port (20ₙ, 22ₘ) of the router via which the cell was received, in order to route all the marked cells (C2) to the management means (3) via the reserved line (6_{R}).

3- An ATM terminal installation (1) comprising the router (2) according to claim 1 or claim 2, connecting external telecommunication lines (5₁-5_{M}) of ATM access networks (RA₁-RA_{M}) and internal telecommunication lines (6₁-6_{N}) servicing terminals (7, 13), characterized in that it further comprises:
management means (3) for managing the routing table (25) included in the router (2) in order to process the cells containing reserved routing addresses routed to the reserved line (6_{R}) and to match unreserved routing addresses (VPI/VCI) included in cells received by the router to unreserved routing addresses to be included in cells to be sent from the router.

4- An installation according to claim 3, characterized in that each terminal (TE) contains at least one reserved routing address (VPI_{R}/VCI_{R}) to be introduced into a cell (C1) sent by the terminal, in particular after activating it or for a call set-up request, and each cell (C1) that contains a reserved routing address (VPI_{R}/VCI_{R}) to be sent by the terminal has a data field including an identifier (NSAP) of the terminal.

5- An installation according to claim 4, characterized in that in response to a marked cell (C2) containing the identifier of the terminal, the management means (3) transmits to the terminal (TE) via the router (2) a cell (C3) which contains the identifier (NSAP) of the terminal and an available routing address (VPI_{RT}/VCI_{RT}) which corresponds to the origin port number (NP) included in the marked cell (C2) and which is to be included subsequently in any dialog cell from the management means (3) to the terminal.

6- An installation according to claim 5, characterized in that the data field of the cell (C3) containing an available routing address (VPI_{RT}/VCI_{RT}) and transmitted by the management means (3) to the terminal (TE) includes, in addition to the identifier (NSAP) of the terminal, an available routing address (VPI_{TE}/VCI_{TE}) assigned to a call between said terminal and another terminal, in response to a routing address in the marked cell (C2) reserved for a call set-up request.

7- An installation according to any of claims 3 to 5, characterized in that the cells containing the reserved routing address (VPI_{R}/VCI_{R}) are processed in a reserved routing address priority order by the management means (3).

8- An installation according to any of claims 3 to 7, characterized by other routing addresses (VPI_{R1}/VCI_{R1}, VPI_{R2}/VCIR₂) reserved for configuring the routing table (25) and transmitted in cells from the management means (3) to the router (2).

9- An installation according to claim 8, characterized in that a routing table configuring cell includes a data field (CD) including a routing address relating to a logical channel for receiving cells in the router (2) and a corresponding routing address relative to a logic channel for sending cells from the router.

10- An installation according to any of claims 3 to 9, comprising at least one individual terminal installation (4) connected to a respective internal line (6ₙ) and including terminals (7), a broadcaster (8D) for broadcasting cells received via the respective internal line to the terminals of the individual installation, and a collector for collecting cells produced by the terminals of the individual installation and transmitting them on the respective internal line to the router (2).

11- An installation according to any of claims 3 to 10, including at least one shared terminal (13) connected to the router (2) by a respective internal telecommunication line (6₂).

12- An installation according to any of claims 3 to 11, including at least one replicator (11, 15) servicing by broadcasting a plurality of terminals (12, 14) and connected to the router (2) by a respective internal telecommunication line (6_{n+1, 6}₁).
